(19) United States
(12) Patent Application Publication
(10) Pub. No.: US 2016/0306883 A1
(43) Pub. Date: Oct. 20, 2016

(54) Business Intelligence Computing System with Offline Usage

(71) Applicant: Tobias Weller, Buseck (DE)

(72) Inventor: Tobias Weller, Buseck (DE)

(21) Appl. No.: 14/690,697

(22) Filed: Apr. 20, 2015

(51) Int. Cl. G06F 17/30; G06Q 10/06

(52) U.S. Cl. CPC G06F 17/30864; G06Q 10/067

(57) ABSTRACT

Data is exported by at least one remote computing system to a client computing device that includes a state description characterizing a navigation state of a business intelligence (BI) application executing on the client computing device that interacts with the at least one remote computing system having at least one associated data source. Thereafter, the at least one remote computing system adjusts a query view state to retrieve a data set corresponding to the current navigation state. Next, metadata of a query and its objects are retrieved and exported that correspond to the adjusted query view state to the client computing device. Further, a data set from the at least one associated data source to the client computing device is retrieved and exported that uses the adjusted query view state.

### TECHNICAL FIELD

The subject matter described herein relates to a business intelligence computing system that provides both online and offline usage.

### BACKGROUND

Business intelligence computing systems (BI) include software and computing hardware that enable the transformation of raw data from a variety of data sources into meaningful and useful information for business analysis purposes. BI computing systems have been widely adopted because they are capable of handling large amounts of unstructured data to help identify, develop and otherwise interpret rich and complex data. However, BI systems typically require active connections to data sources and do not permit meaningful offline use.

### SUMMARY

In one aspect, data is exported by at least one remote computing system to a client computing device that includes a state description characterizing a navigation state of a business intelligence (BI) application executing on the client computing device that interacts with the at least one remote computing system having at least one associated data source. Thereafter, the at least one remote computing system adjusts a query view state to retrieve a data set corresponding to the current navigation state. Next, metadata of a query and its objects are retrieved and exported that correspond to the adjusted query view state to the client computing device. Further, a data set from the at least one associated data source to the client computing device is retrieved and exported that uses the adjusted query view state.

The exporting data comprising the state description can include writing the data to a target file or input stream at the client computing device.

Adjusting the query view state can include specifying a data set that is larger than the data set required by the current navigation state to allow additional navigation when the BI application is offline and is not able to interact with the at least one remote computing system.

The data set can be converted into a plurality of records.

A data source can be generated locally on the client computing device using the exported metadata and the records. The records can be read and parsed to populate the local data source. A query view object can be parsed and applied on top of the local data source using the state description.

In an interrelated aspect, data is received by a client computing device from a remote computing system that includes a metadata description, a plurality of records, and a state description, the state description characterizing a navigation state of a business intelligence (BI) application executing on the client computing device that interacts with the at least one remote computing system having at least one associated data source. Thereafter, a local data source is generated at the client computing device based on the metadata description. Records are read and parsed to populate the local data source and a query view object is parsed and applied on top of the local data source using the state description.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many technical advantages. For example, the current subject matter enables use of a BI application on a client device in an offline mode (i.e., a mode in which there are no active connections to relevant data sources and/or a mode that operates solely locally without interaction with a remote server, etc.). The current subject matter is also advantageous in that it can be used for the rapid retrieval of data from a back-end system for demos, testing or validation.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a business intelligence consumer services computing system architecture;

FIG. 2 is a diagram illustrating an aspect of a business intelligence server architecture;

FIG. 3 is a diagram illustrating a result set before and after a query view state is adjusted;

FIG. 4 is a diagram illustrating conversion of a data set into records;

and

FIG. 5 is a diagram illustrating a process flow diagram for enabling offline use of a business intelligence application.

Like reference symbols in the various drawings indicate like elements.

### DETAILED DESCRIPTION

The current subject matter describes apparatus, systems, and computer program products that enable selectively switching from online to offline in a client computing device. Such an arrangement is implemented in a non-disruptive manner by exporting the current navigational state, metadata and all the data to local files (i.e., files local to the client). Afterwards, a new local cube can be built (at the client device) based on this data and the navigational state can be recreated. By doing so a user can directly continue working on the client device at the point at which he or she stopped before switching to offline mode.

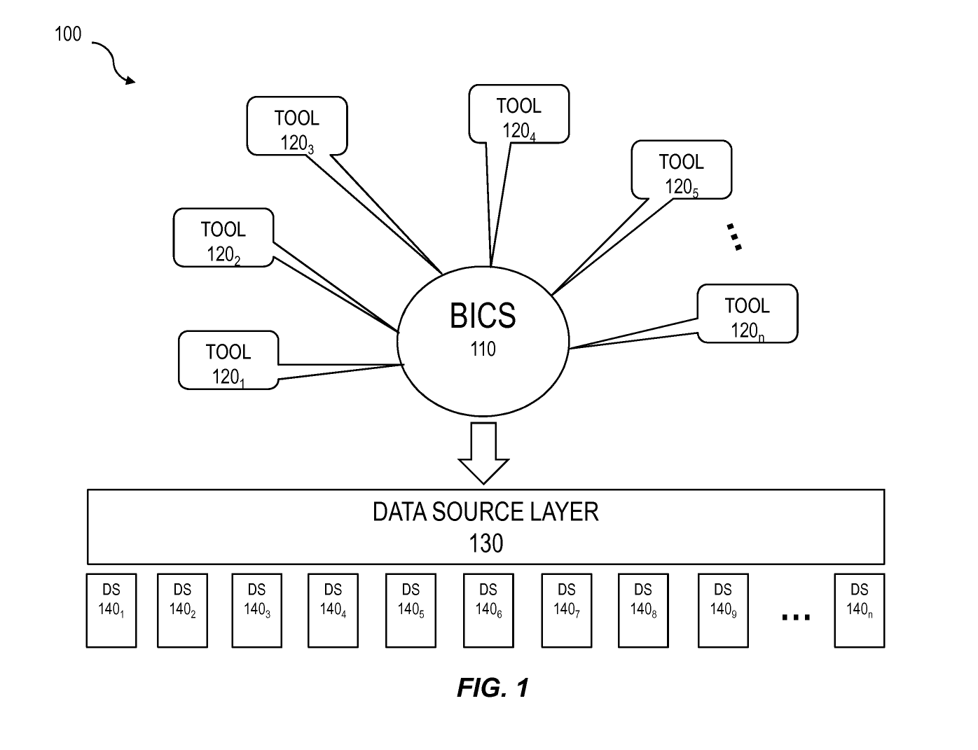

FIG. 1 is a diagram 100 illustrating a sample business intelligence architecture that includes a data access layer 110 (also referred to herein as business intelligence consumer services or BICS) that interfaces with a plurality of tools 120_{1 . . . n}, which in turn, can access a plurality of data sources 140_{1 . . . n} via at least one data source layer 130. These tools 120_{1 . . . n} can include, for example, business intelligence (BI) frontend tools, planning applications and JAVA applications running in a portal to work with selections and access data, such as OLAP data, in a unified way for different data sources 140_{1 . . . n}. These different data sources 140_{1 . . . n} can store data (which can also have differing formats) in a variety of ways including data that is stored in an SAP BUSINESS WAREHOUSE platform and SAP HANA platform as well as other types of data sources. As mentioned above, the data stored in the data sources 140_{1 . . . n} can be of different formats including relational data such as CSV files.

As will be described in further detail below, there are numerous scenarios in which a BI Client wants to make its data and workflow available for offline usages. Workflow, in this regard, can refer to the particular graphical user interfaces, reports, and other sequences of information being displayed to a user for interaction and other BI purposes.

In a first example, with the current subject matter, a sales person can analyze sales data of his or her products on the way to the airport. The data is currently stored in a data warehouse system of the company (i.e., a remotely stored database/persistence) (which corresponds to one of the data sources 140_{1 . . . n} of FIG. 1). The sales person uses a query which, using a BI client (corresponding to one of the tools_{1 . . . n} of FIG. 1), has already been adjusted using a graphical user interface of such BI tool by drilling and filtering (which form part of the workflow) to see the data he or she was seeking. When the sales person enters the plane, the sales person wants to continue working with the exact same data and the exact same workflows in the BI tool. Therefore, the sales person wants to switch the BI client to offline without having to do anything else. The client uses a data access layer to access data and support analytical workflows. The client itself only takes care of the visualization. So the offline capabilities need to be included in this data access layer, otherwise the client components and workflows will not work anymore.

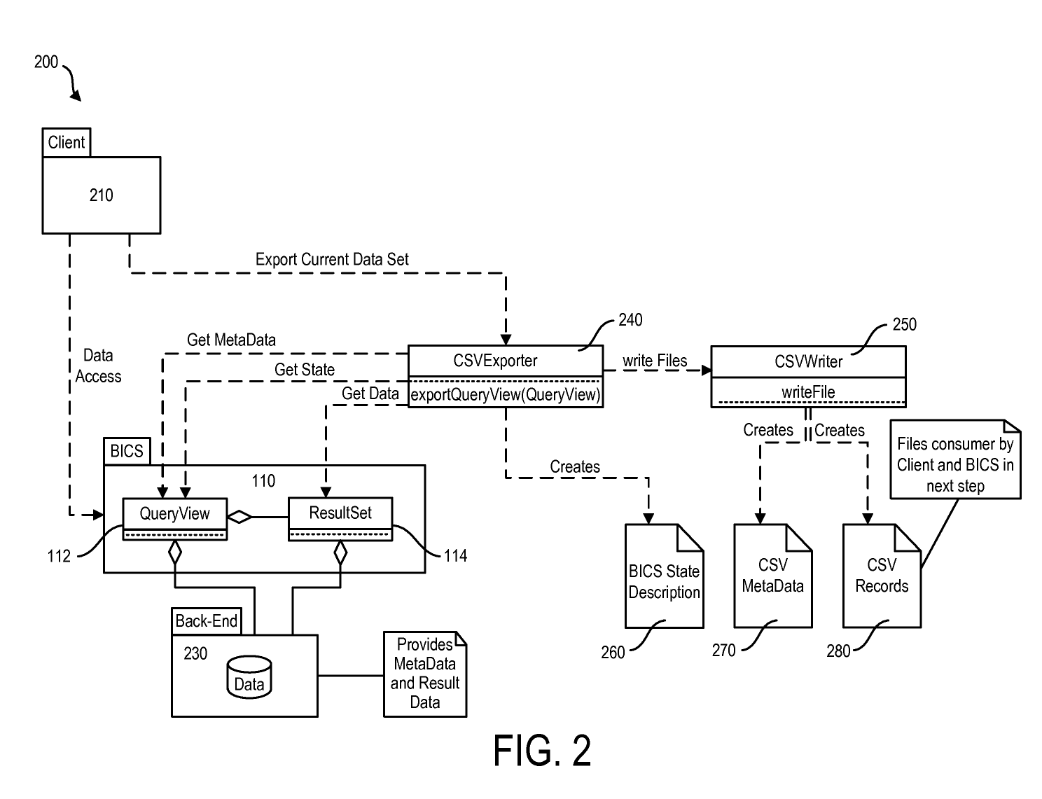

With reference to diagram 200 of FIG. 2, in order to continue working with the same data and state in an offline mode, three components can be utilized, namely metadata 270, the data set 280, and a state description 260. The metadata 270 can be a metadata description of the data set 280 that includes information about what objects are contained in the data set, which object types form part of the data set, formatting settings (e.g., how data is displayed, reported, graphical user interface elements and preferences, etc.), and the like.

The dataset 280 can be a collection/list of records that contain the complete data set of the data source 140_{1 . . . n} the user was working with.

The state description 260 is a description of the navigational state (filter, drill down, settings, etc.) of the data source 140_{1 . . . n}, which can be applied again to another data source 140_{1 . . . n} to recreate the same state. In this regard, navigational state refers to manipulations made to a data set using a business intelligence (BI) application executing on a client computing device that interacts with at least one remote computing system that has at least one associated data source.

With the current arrangement, a data source DS_{BE} 230 based on a back-end connection (e.g., query 112, etc.) or result set 114, etc. can export these three components 260, 270, 280 to a portable target capable of being sent to various devices for offline usage (e.g. simple files, etc.). Then, the client (i.e., the portable target) can create a second local data source DS_{local} (not shown), which is based on the metadata and records that were previously exported. And finally, the exported state of DS_{BE} 230 can be applied to DS_{local}.

In the end, the navigational state and data of both data sources DS_{BE} 230 and DS_{local} can be equal. So the client can replace DS_{BE} with DS_{local} and the user keeps on working—but now offline—without being heavily disrupted.

Still further, synchronization from an offline state to an online state can be provided in some implementations. In particular, the state of DS_{local} can be exported, DS_{BE} can be recreated and the exported state can be applied to DS_{BE}.

With reference again to FIG. 2, a client 210 can be connected to a back-end system 230 via BICS 110 and hold an active instance to a query view 112, which contains the metadata and state description of a data source. Then the export can be triggered, which leads to the creation of an exporter service 240, which handles the export.

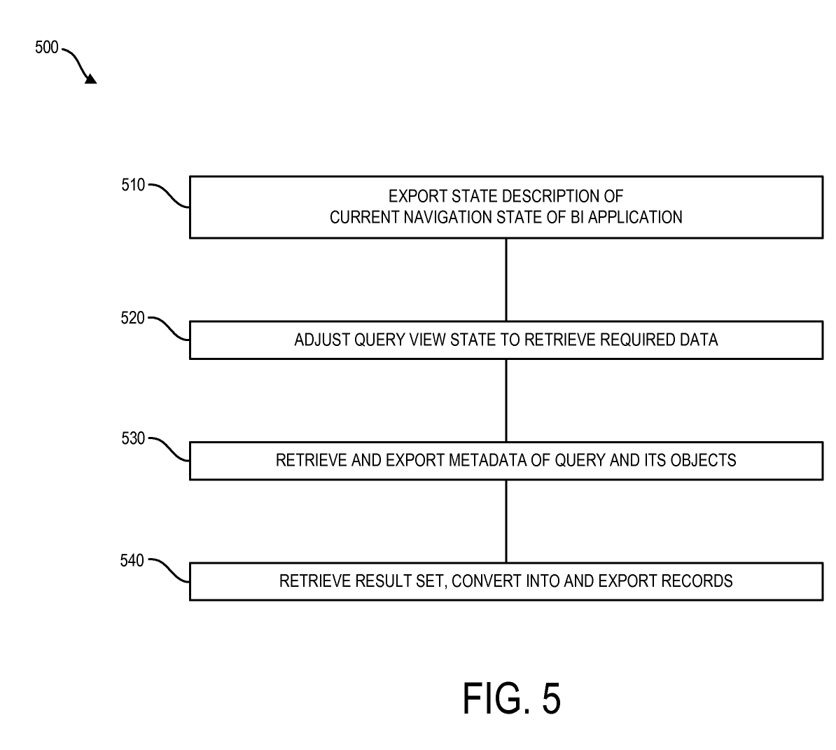

The exporter service 240 can get the query view 112 handed over. Subsequently, the following actions can be performed (with reference to diagram 500 of FIG. 5):

1. Export the state description of the current navigation state of BI application (510);

2. Adjust the query view state to retrieve all required data (520);

3. Retrieve and export the metadata of the query and its objects (530);

4. Retrieve and convert the data (result set) into records and export records (540).

Export the State Description.

A BICS state XML file can be used to represent the state of a data source; this is an already existing XML-format, which describes the complete state of a BICS data source 140_{1 . . . n}. The exporter service 240 can retrieve the state in this XML-format and write it to a target file or whatever target is specified (input stream, etc.).

Adjust the Query View State.

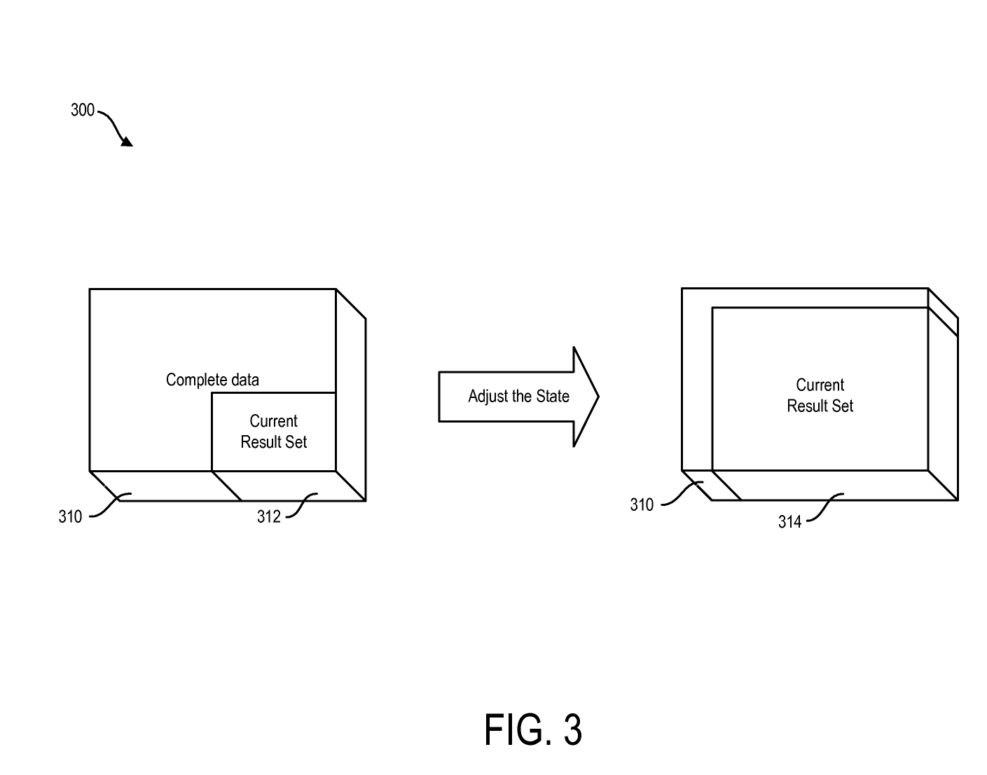

With reference to diagram 300 of FIG. 3, the query view state initially, from a complete data set 310, only uses a current result set 312 which forms a subset of the complete data set. However, this current result set 312 must be adjusted in such a way that following export of the result set (records), the current result set 314 is capable of providing all necessary data, so that afterwards in the offline usage all data is available to support a wide set of navigations beyond what was being utilized when online. Stated differently, without adjusting the query view state, the client would only be able to view the current data or less. However, by adjusting the state as provided herein, it can also be possible to change the state of the BI client to view other data.

The reason why not everything is returned is as often there are specific limitations that prevents the exporter from exporting everything or the data volume is reduced to save memory and processing time.

The ultimate target here is to have the result set look like if it is a flat relational data set (although of course it still it multidimensional). Reason for that is to ease the export process as then the source result set and the target flat record file basically have the same structure.

And finally some settings need to be changed and/or removed to get the correct data as the numbers in the result set could have been changed by changing their formatting or by adding local calculations. For example there might have been a scaling factor defined for one measure, which would mean all exported data would be wrong by this scaling factor (in the result set we have “100” with scaling factor *10 so the real value would be 1000, but we would export 100).

To address such goals, the following steps can be performed:

Move all dimensions to the rows axis
To have the result set look virtually relational.

Move measures to the columns axis
To have the result set look virtually relational.

Add all presentations of the dimensions to the result set
Not only show the text of the dimension member in the result set but instead show their key, display key and text (and even more if supported).

Add all attributes of the dimensions to the result set
To get the data as well so that they can be used in the local data source.

Remove Totals for all dimensions
The totals are later on calculated within the local data source, so we don't need to export them.

Remove Local Calculations
To get the correct data.

Remove Formatting
e.g. scaling factors, decimal places to maximum, reverse sign off—Again to get the correct data.

Export Metadata.

Next, all metadata that is required to reproduce the data source locally afterwards can be exported from the BI server to the client computing device. This metadata can describe the data that will be exported in the next step in the same way that it was in a non-local mode when the metadata was coming from a back-end system (business warehouse, HANA platform, etc.).

So for each object (Dimension, Attribute, Measure) in the Query View the following information can be exported:

Role
The object's role (Dimension, Attribute, Measure)

Name
The object's unique name used to identify it at any point in time.

Description
A readable description.

Presentations
All the available and exported presentations of the object's members (Key, Text, Display Key, etc.).

Attributes
List the attributes that belong to a dimension.

Data Type
Data type of the object (String, Integer, Date, Percent, etc.).

Unit/Currency
Identify whether the object has a unit or currency assigned to it and where to find the information.

Aggregation type
Describes how the object should be aggregated (sum, count, average).

In addition global settings need to be exported, which describe the formatting of the data.

Decimal formatting

Decimal separator; 1000 group separator (1.000 or 1,000).

Date formatting

Format of dates.

Time zone

The time zone in which the data is stored.

The following table shows a partial example of how an exported metadata description file 270 might look like:

<<BEGIN OF METADATA>>
<<BEGIN OF ROLESUPPORT>>

| Role | Name | Descriptio [symbol] | Field | Reference | Presentat [symbol] | Data Types |
|---|---|---|---|---|---|---|
| CHARACTERISTIC | 0BC_CUST [symbol] | Land | 1 | | TEXT | UPPER_CASE_STRING |
| CHARACTERISTIC | 0BC_CUST [symbol] | Land | 2 | | KEY | UPPER_CASE_STRING |
| ATTRIBUTE | 0BC_COU [symbol] | Land | 3 | OBC_CUST [symbol] | SHORT_TE [symbol] | UPPER_CASE_STRING |
| KEYFIGURE | 4FQ8MSO [symbol] | Max. Men [symbol] | 4 | | VALUE | DOUBLE |
| KEYFIGURE | 4FQ8MSO [symbol] | Max. Men [symbol] | 5 | | UNIT | STRING |
| KEYFIGURE | 4FQ8MSW [symbol] | Min. Men [symbol] | 6 | | VALUE | DOUBLE |
| KEYFIGURE | 4FQ8MSW [symbol] | Min. Men [symbol] | 7 | | UNIT | STRING |
| <<END OF ROLESUPPORT>> | | | | | | |
| <<BEGIN OF FORMAT SETTINGS>> | | | | | | |
| TYPE | VALUE | | | | | |
| GROUP SEPARATOR | , | | | | | |
| DECIMAL SEPARATOR | . | | | | | |
| DATE SEPARATOR | . | | | | | |
| STANDARD TIMEZONE | GMT | | | | | |

<<END OF FORMAT SETTINGS>>
<<END OF METADATA>>

[symbol]

indicates data missing or illegible when filed

Export Records.

In the final export step the actual data (i.e., the records) can be exported. Due to the previous preparation of the query view state (i.e., the adjusted query view state), the data is already in a good format for exporting it as it is already in a virtually relational format (it looks like a flat relational data set, but still is multidimensional), which eases the export.

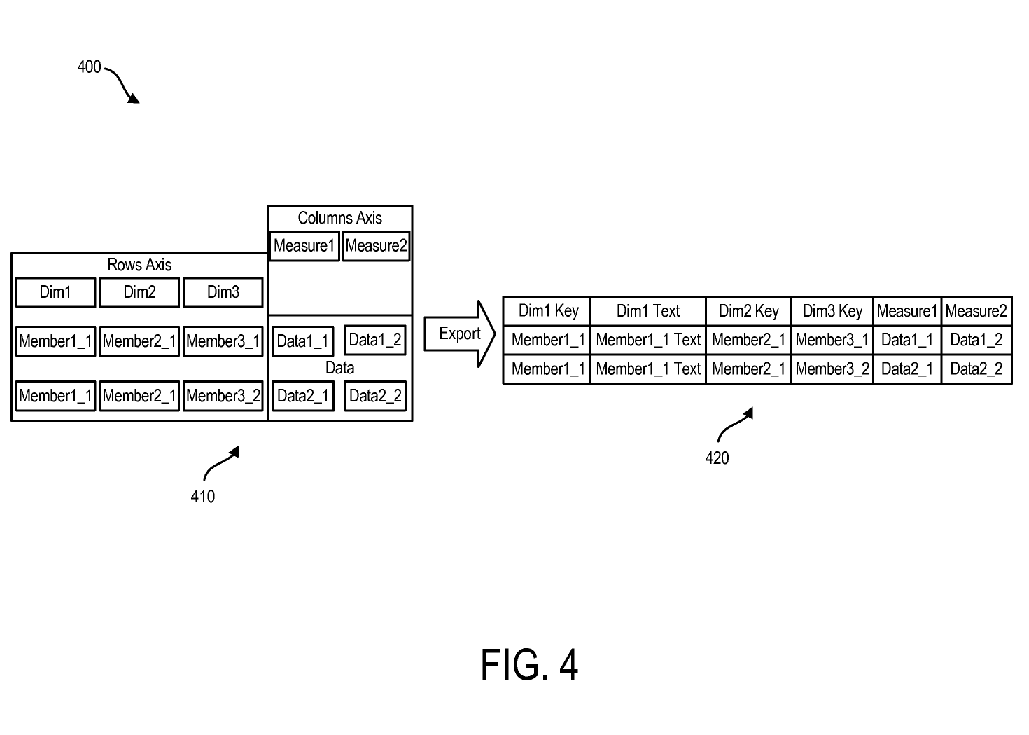

FIG. 4 is a diagram 400 that illustrates the export input and output. The right side 420 illustrates how an exported flat records list might look like (note that for each dimension multiple columns might be created for all of their presentations). The export itself is done by retrieving the result set from the query view (shown on the left side 410 in FIG. 4) and then iterating over the complete result set, starting by the first rows tuple, at the end of each rows tuple the data cells (the values) assigned to this tuple and each measure are read and exported and then we'll move to the next rows tuple.

Consume Exported Data.

After the export operations described above, the three files are available, metadata description 270, the records 280, and the state description 260. Next, a new local BICS Data Source can be created based on the metadata description 270. Then the records 280 are read and parsed, which form a cube of a new data source, so the complete data set is available. And in the final step, the state description 260 is parsed and applied so that a new query view object on top of this local data source is available for the user and behaves similar to the previous data source apart from the fact that it is offline now.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
exporting, to a client computing device by at least one remote computing system, data comprising a state description characterizing a navigation state of a business intelligence (BI) application executing on the client computing device that interacts with the at least one remote computing system having at least one associated data source;
adjusting, by the at least one remote computing system, a query view state to retrieve a data set corresponding to the current navigation state;
retrieving and exporting metadata of a query and its objects that correspond to the adjusted query view state to the client computing device; and
retrieving and exporting, using the adjusted query view state, a data set from the at least one associated data source to the client computing device.

2. The method of claim 1, wherein the exporting data comprising the state description comprises writing the data to a target file or input stream at the client computing device.

3. The method of claim 1, wherein adjusting the query view state comprises specifying a data set that is larger than the data set required by the current navigation state to allow additional navigation when the BI application is offline and is not able to interact with the at least one remote computing system.

4. The method of claim 1 further comprising:
converting the data set into a plurality of records.

5. The method of claim 1 further comprising:
generating a data source locally on the client computing device using the exported metadata and the records.

6. The method of claim 5 further comprising:
reading and parsing the records to populate the local data source.

7. The method of claim 6 further comprising:
parsing and applying a query view object on top of the local data source using the state description.

8. A system comprising:
at least one data processor; and
memory storing instructions which, when executed by the at least one data processor, result in operations comprising:
exporting, to a client computing device by the at least one data processor, data comprising a state description characterizing a navigation state of a business intelligence (BI) application executing on the client computing device that interacts with the at least one remote computing system having at least one associated data source;
adjusting, by the at least one data processor, a query view state to retrieve a data set corresponding to the current navigation state;
retrieving and exporting metadata of a query and its objects that correspond to the adjusted query view state to the client computing device; and
retrieving and exporting, using the adjusted query view state, a data set from the at least one associated data source to the client computing device.

9. The system of claim 8, wherein the exporting data comprising the state description comprises writing the data to a target file or input stream at the client computing device.

10. The system of claim 8, wherein adjusting the query view state comprises specifying a data set that is larger than the data set required by the current navigation state to allow additional navigation when the BI application is offline and is not able to interact with the at least one remote computing system.

11. The system of claim 8, wherein the operations further comprise:
converting the data set into a plurality of records.

12. The system of claim 8, wherein the operations further comprise:
generating a data source locally on the client computing device using the exported metadata and the records.

13. A computer implemented method comprising:
receiving, by a client computing device from a remote computing system, data comprising a metadata description, a plurality of records, and a state description, the state description characterizing a navigation state of a business intelligence (BI) application executing on the client computing device that interacts with the at least one remote computing system having at least one associated data source,
generating, at the client computing device, a local data source based on the metadata description;
reading and parsing the plurality of records to populate the local data source; and
parsing and applying a query view object on top of the local data source using the state description.

14. The method of claim 13 further comprising:
exporting, by the remote computing system to the client computing device, the received data.

15. The method of claim 14 further comprising:
adjusting, by the at least one remote computing system, a query view state to retrieve a data set corresponding to the current navigation state.

16. The method of claim 15 further comprising:
retrieving and exporting metadata of a query and its objects that correspond to the adjusted query view state to the client computing device.

17. The method of claim 15 further comprising:
retrieving and exporting, using the adjusted query view state, a data set from the at least one associated data source to the client computing device.
